(19) United States
(12) Patent Application Publication
(10) Pub. No.: US 2025/0277529 A1
(43) Pub. Date: Sep. 4, 2025

(54) SERVICE VALVE FOR AIR CONDITIONER, WHICH CAN PREVENT SPINDLE WEAR

(71) Applicant: Samsung Electronics Co., Ltd., Suwon-si (KR)

(72) Inventors: Jungwoo HWANG, Suwon-si (KR); Sangpill YOON, Suwon-si (KR); Duhan JUNG, Suwon-si (KR)

(21) Appl. No.: 19/211,890

(22) Filed: May 19, 2025

Related U.S. Application Data
(63) Continuation of application No. PCT/KR2023/019679, filed on Dec. 1, 2023.

(30) Foreign Application Priority Data
Dec. 26, 2022 (KR) 10-2022-0184898

(51) Int. Cl. F16K 1/02; F16K 31/50; F24F 1/26

(52) U.S. Cl. CPC F16K 1/02; F16K 31/50; F24F 1/26

(57) ABSTRACT

A service valve for use in an air conditioner may include: a body; a fluid passage formed to penetrate the body; a spindle receiving part formed to communicate with the fluid passage; a spindle screw-connected to the spindle receiving part and configured to open and block the fluid passage; a guard hole formed at a certain depth on an upper surface of the spindle; and a wrench guard disposed in the guard hole.

### CROSS-REFERENCE TO RELATED APPLICATIONS

This application is a continuation application of International Application No. PCT/KR2023/019679 designating the United States, filed on Dec. 1, 2023, in the Korean Intellectual Property Receiving Office and claiming priority to Korean Patent Application No. 10-2022-0184898, filed on Dec. 26, 2022, the disclosures of which are all hereby incorporated by reference herein in their entireties.

### BACKGROUND

### Technical Field

Certain example embodiments may relate to an air conditioner, and for example, to a service valve to be used in an air conditioner.

### Background Art

Generally, an air conditioner may include an indoor unit and an outdoor unit.

The indoor unit may include an indoor fan and an evaporator. The outdoor unit may include a compressor, a condenser, an expansion valve, and an outdoor fan.

The compressor, the condenser, the expansion valve, and the evaporator are connected by piping so that refrigerant may circulate.

The indoor unit and the outdoor unit are disposed in separate locations. Therefore, after disposing the indoor unit and the outdoor unit, the indoor unit and the outdoor unit may be connected to each other using a connecting piping.

A service valve may be used to connect the connecting pipe connected to the indoor unit and the outdoor unit.

When the service valve is open, the refrigerant may flow through the piping. When the service valve is closed, the refrigerant may not flow through the piping. In other words, the service valve may control the flow of refrigerant circulating between the indoor unit and the outdoor unit.

### SUMMARY

Certain example embodiments may provide a service valve for an air conditioner capable of preventing or reducing spindle wear.

According to an example embodiment, a service valve for air conditioner may include: a body; a fluid passage formed to penetrate the body; a spindle receiving part formed to communicate, directly or indirectly, with the fluid passage; a spindle screw-connected, directly or indirectly, to the spindle receiving part and configured to open and block the fluid passage; a guard hole formed at a certain depth on an upper surface of the spindle; and a wrench guard disposed in the guard hole.

The wrench guard may be formed in a sleeve shape including a through hole, and a cross-section of the through hole may be a regular hexagon.

The guard hole may be formed as a polygonal hole. An outer circumferential surface of the wrench guard may be formed as a polygon corresponding to the polygonal hole of the guard hole.

The polygonal hole may be formed as one of a square hole, a hexagonal hole, and a polygonal star hole.

The guard hole may be formed as an elliptical hole. An outer circumferential surface of the wrench guard may be formed as an elliptical shape corresponding to the elliptical hole of the guard hole.

The wrench guard may include a stopper provided at an upper end of the wrench guard. The wrench guard may be fixed to the guard hole by the stopper.

The wrench guard may include a fixing protrusion provided on an outer circumferential surface of the wrench guard. The wrench guard may be fixed to the guard hole by the fixing protrusion.

The spindle may further include a wrench hole formed below the guard hole.

A length of the wrench guard may be equal to or greater than a depth of the wrench hole.

The length of the wrench guard may be at least 5 mm.

A material of the body may be brass, and a material of the wrench guard may be stainless steel.

The stainless steel may be STS 304 and/or STS 316, as examples.

The body may be formed in a cross shape. The fluid passage may be formed on an inside of a leg, a center portion, and a right arm of the body. The spindle receiving part may be formed to connect an upper surface of a head of the body 10 and the center portion.

The spindle receiving part may include a female screw portion. The spindle may include a screw portion fastened to the female screw portion.

The service valve may further include a charging core disposed in a left arm of the body.

### BRIEF DESCRIPTION OF DRAWINGS

These and/or other aspects, features, and advantages of certain embodiments of the disclosure will be more apparent from the following description taken in conjunction with the accompanying drawings, in which:

FIG. 1 is a perspective view illustrating a service valve 1 for an air conditioner according to an example embodiment.

FIG. 2 is a cross-sectional perspective view illustrating a service valve 1 for an air conditioner according to an example embodiment.

FIG. 3 is a perspective view illustrating a spindle 40 of a service valve 1 for an air conditioner according to an example embodiment.

FIG. 4 is a cross-sectional view illustrating the spindle 40 of FIG. 3.

FIG. 5 is an exploded perspective view illustrating the spindle 40 of FIG. 3.

FIG. 6 is a cross-sectional perspective view illustrating the spindle 40 of FIG. 3 without a wrench guard 50.

FIG. 7 is a cross-sectional view illustrating a spindle 40 of a service valve 1 for an air conditioner according to an example embodiment.

FIG. 8 is a cross-sectional view illustrating a spindle 40 of a service valve 1 for an air conditioner according to an example embodiment.

FIG. 9 is a perspective view illustrating a spindle 40 of a service valve 1 for an air conditioner according to an example embodiment.

FIG. 10 is a cross-sectional view illustrating the spindle 40 of FIG. 9.

FIG. 11 is an exploded perspective view illustrating the spindle 40 of FIG. 9.

FIG. 12 is a cross-sectional perspective view illustrating the spindle 40 of FIG. 9 without a wrench guard 50.

FIG. 13 is a perspective view illustrating a wrench guard 50 used in a spindle 40 of a service valve 1 for an air conditioner according to an example embodiment.

FIG. 14 is a perspective view illustrating the spindle 40 of a service valve 1 for an air conditioner according to an example embodiment, in which the wrench guard 50 of FIG. 13 is disposed.

FIG. 15 is a perspective view illustrating a wrench guard 50 used in a spindle 40 of a service valve 1 for an air conditioner according to an example embodiment.

FIG. 16 is a perspective view illustrating the spindle 40 of a service valve 1 for an air conditioner according to an example embodiment, in which the wrench guard 50 of FIG. 15 is disposed.

FIG. 17 is a cross-sectional view illustrating a spindle 40 of a service valve 1 for an air conditioner according to an example embodiment.

FIG. 18 is a cross-sectional view illustrating a wrench guard 50 used in the spindle 40 of FIG. 17.

FIG. 19 is a cross-sectional view illustrating a wrench guard 50 used in a spindle 40 of a service valve 1 for an air conditioner according to an example embodiment.

FIG. 20 is a cross-sectional view illustrating a spindle 40 of a service valve 1 for an air conditioner according to an example embodiment.

FIG. 21 is a cross-sectional perspective view illustrating a wrench guard 50 used in the spindle 40 of FIG. 20.

FIG. 22 is a cross-sectional perspective view illustrating a wrench guard 50 used in a spindle 40 of a service valve 1 for an air conditioner according to an example embodiment.

FIG. 23 is a cross-sectional view illustrating a state in which a service valve 1 for an air conditioner according to an example embodiment is closed by a spindle 40.

FIG. 24 is a cross-sectional view illustrating a state in which a service valve 1 for an air conditioner according to an example embodiment is opened by a spindle 40.

FIG. 25 is a cross-sectional view illustrating a state in which a wrench is inserted into a wrench hole 42 of a spindle 40 of a service valve 1 for an air conditioner according to the prior art.

### DETAILED DESCRIPTION

Since the embodiments of the disclosure can apply various transformations and have various embodiments, specific embodiments will be illustrated in the drawings and described in detail in the detailed description. However, this is not intended to limit the scope to the specific embodiments, and should be understood to include various modifications, equivalents, and/or alternatives of the example embodiment. In connection with the description of the drawings, like reference numerals may be used for like elements.

In describing the disclosure, when it is determined that a detailed description of a

related known function or configuration may unnecessarily obscure the gist of the disclosure, a detailed description thereof will be omitted.

In addition, the following embodiments may be modified in many different forms, and the scope of the technical idea of the disclosure is not limited to the following embodiments. Rather, these embodiments are provided so that this disclosure will be thorough and complete, and will fully convey the spirit of the disclosure to those skilled in the art.

Terms used in this disclosure are only used to describe specific embodiments, and are not intended to limit the scope of rights. Singular expressions include plural expressions unless the context clearly dictates otherwise.

In this disclosure, expressions such as “has,” “can have”, “includes,” or “can include” indicate the existence of a corresponding feature (e.g., numerical value, function, operation, or component such as a part) and do not preclude the existence of additional features.

In this disclosure, expressions such as “A or B,” “at least one of A or/and B,” or “one or more of A or/and B” may include all possible combinations of the items listed together. For example, “A or B,” “at least one of A or/and B,” or “one or more of A or/and B” may refer to all cases (1) including at least one A, (2) including at least one B, or (3) including both at least one A and at least one B.

Expressions such as “first,” “second,” “primary,” or “secondary,” as used in this disclosure may modify various components regardless of order and/or importance, are used only to distinguish one component from other components, and do not limit the corresponding components.

Further, terms such as ‘leading end’, ‘rear end’, ‘upper side’, ‘lower side’, ‘top end’, ‘bottom end’, etc. used in the disclosure are defined with reference to the drawings. However, the shape and position of each component are not limited by these terms.

Hereinafter, embodiments of a service valve 1 for an air conditioner according to the disclosure will be described in detail with reference to the attached drawings.

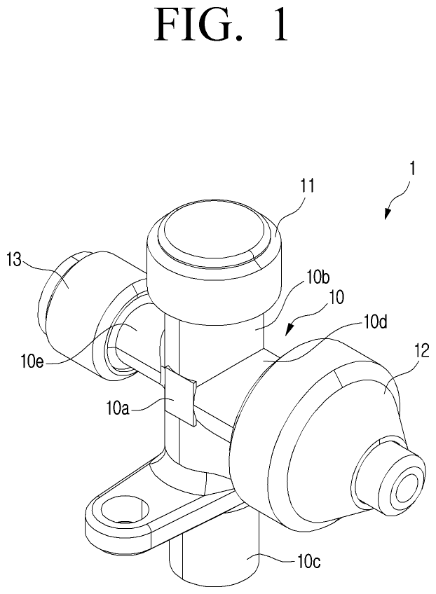

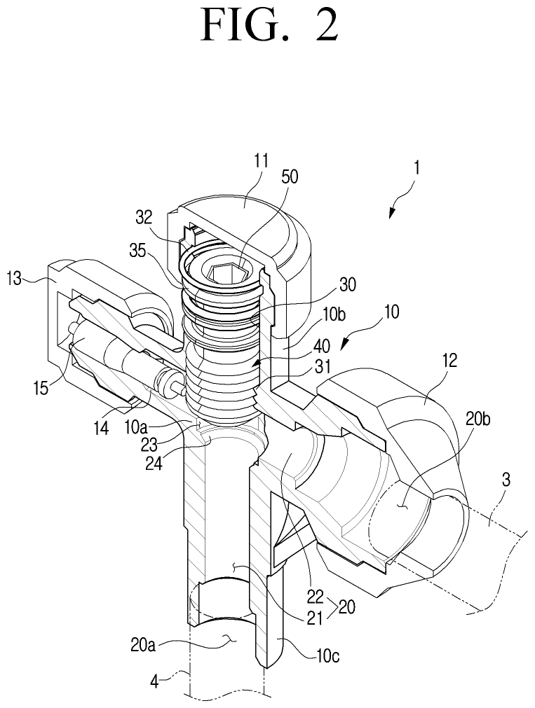

FIG. 1 is a perspective view illustrating a service valve 1 for an air conditioner according to an example embodiment. FIG. 2 is a cross-sectional perspective view illustrating a service valve 1 for an air conditioner according to an example embodiment.

A service valve 1 for an air conditioner according to an example embodiment may include a body 10, a fluid passage 20, a spindle receiving part 30, and a spindle 40.

The body 10 may form the appearance of the service valve 1 for an air conditioner. The body 10 may be formed of brass.

The fluid passage 20 may be formed to penetrate the body 10. In other words, two openings 20a and 20b connected to both ends of the fluid passage 20 may be provided on the surface of the body 10.

The spindle receiving part 30 may be formed to communicate, directly or indirectly, with the fluid passage 20. In other words, the spindle receiving part 30 may be formed to be connected, directly or indirectly, to the fluid passage 20 in the body 10. The spindle receiving part 30 may be formed as a hole connecting the surface of the body 10 and the fluid passage 20.

The spindle 40 may be disposed in the spindle receiving part 30. The spindle 40 may be screw-fastened to the spindle receiving part 30, and may be configured to open and close the fluid passage 20.

Referring to FIGS. 1 and 2, the body 10 may be formed in an approximately cross shape. In other words, the body 10 may include four branches extending perpendicularly from the center portion of the body 10. The four branches may be formed in an approximately circular pipe shape.

A branch extending upward from the center portion 10a of the body 10 may be referred to as a head 10b. A branch extending downward from the center portion 10a of the body 10 may be referred to as a leg 10c. Branches extending right and left from the center portion 10a of the body 10 may be referred to as a right arm 10d and a left arm 10e.

The right arm 10d may be connected, directly or indirectly, to a connecting pipe 3 connected to an indoor unit. A flare nut 12 may be disposed at one end of the right arm 10d. Accordingly, the right arm 10d and the connecting pipe 3 may be connected by the flare nut 12.

The leg 10c may be connected, directly or indirectly, to a pipe 4 of an outdoor unit.

The fluid passage 20 may be formed inside the leg 10c, the center portion 10a, and the right arm 10d. In other words, the fluid passage 20 may be formed to penetrate the leg 10c, the center portion 10a, and the right arm 10d of the body 10. Accordingly, refrigerant may flow through the fluid passage 20 formed inside the body 10.

The fluid passage 20 may include a first fluid passage 21 formed in the longitudinal direction of the leg 10c, a second fluid passage 22 formed in the longitudinal direction of the right arm 10d, and a central space 23 formed in the center portion 10a and connecting the first fluid passage 21 and the second fluid passage 22. In other words, the fluid passage 20 may be formed by the first fluid passage 21, the central space 23, and the second fluid passage 22.

A charging passage 14 communicating with the center portion 10a may be provided inside the left arm 10e. A charging core 15 may be disposed at one end of the left arm 10e. The refrigerant may be injected into the fluid passage 20 using the charging core 15. A core cap 13 may be provided at one end of the left arm 10e.

The spindle receiving part 30 may be formed in the head 10b of the body 10 to be in communication with the center portion 10a. The spindle receiving part 30 may be formed to connect the upper surface of the head 10b and the center portion 10a. In other words, the spindle receiving part 30 may be in communication with the central space 23 of the center portion 10a.

A female screw portion 31 may be provided on the inner surface of the spindle receiving part 30. The female screw portion 31 may be provided so as to be adjacent to the fluid passage 20. The female screw portion 31 of the spindle receiving part 30 may be formed so that a screw portion 44 of the spindle 40 may be fastened.

The spindle 40 may be disposed in the spindle receiving part 30. The spindle 40 may be disposed so as to move up and down with respect to the spindle receiving part 30. The spindle 40 may include the screw portion 44. The screw portion 44 may be formed as a male screw. The screw portion 44 of the spindle 40 may be formed as a male screw corresponding to the female screw portion 31 of the spindle receiving part 30. Therefore, the spindle 40 may be screw-coupled to the inside of the spindle receiving part 30.

Because the spindle 40 and the spindle receiving part 30 are screw-connected, directly or indirectly, the rotational motion of the spindle 40 may be converted into the linear motion of the spindle 40.

For example, when the spindle 40 is rotated, the spindle 40 may move linearly up and down inside the spindle receiving part 30. In detail, when the spindle 40 is rotated in one direction, the spindle 40 may move downward in the spindle receiving part 30. When the spindle 40 is rotated in the opposite direction, the spindle 40 may move upward in the spindle receiving part 30.

A spindle seat 24 corresponding to the lower end of the spindle 40 may be provided at the lower end of the center portion 10a of the body 10, that is, at the upper end of the leg 10c. The spindle seat 24 may be formed as a chamfer at the upper end of the first fluid passage 21. In other words, the spindle seat 24 may be provided below the spindle receiving part 30.

A chamfer 45 corresponding to the spindle seat 24 may be provided at the lower end of the spindle 40. Accordingly, when the chamfer 45 at the lower end of the spindle 40 comes into contact with the spindle seat 24, the refrigerant may not flow between the lower end of the spindle 40 and the spindle seat 24. In other words, when the lower end of the spindle 40 is in contact with the spindle seat 24, the first fluid passage 21 may be blocked. Then, the fluid passage 20 may be blocked so that the refrigerant may not flow through the fluid passage 20.

When the spindle 40 moves upward and the lower end of the spindle 40 is not in contact with the spindle seat 24, the refrigerant may flow between the lower end of the spindle 40 and the spindle seat 24.

At least one O-ring 35 may be disposed on the upper portion of the spindle 40. In detail, at least one O-ring groove 47 may be provided on the upper portion of the spindle 40, that is, above the screw portion 44. An O-ring 35 may be disposed in the at least one O-ring groove 47. The O-ring 35 may prevent the refrigerant from leaking between the spindle 40 and the spindle receiving part 30.

In this embodiment, two O-ring grooves 47 and two O-rings 35 disposed in the two O-ring grooves 47 may be provided at the upper portion of the spindle 40.

A stop ring 32 may be disposed on the upper end of the spindle receiving part 30. The stop ring 32 may be provided to prevent the spindle 40 from falling out of the spindle receiving part 30. Accordingly, when high pressure is applied to the fluid passage 20, the spindle 40 may not fall out of the spindle receiving part 30.

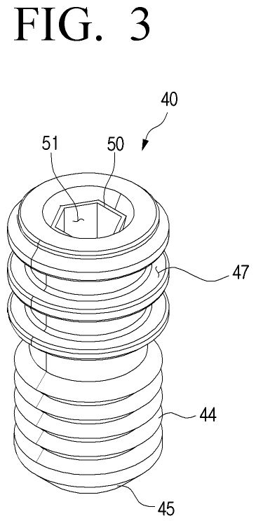

Hereinafter, the spindle 40 according to an example embodiment will be described in detail with reference to FIGS. 3 to 6.

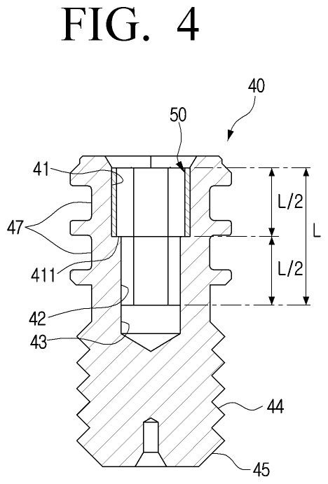

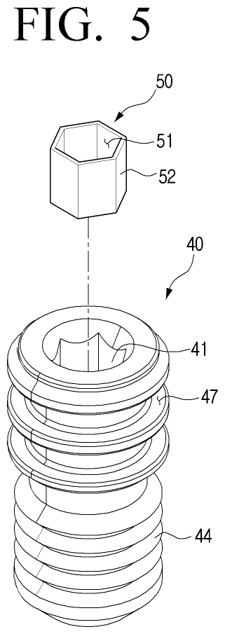

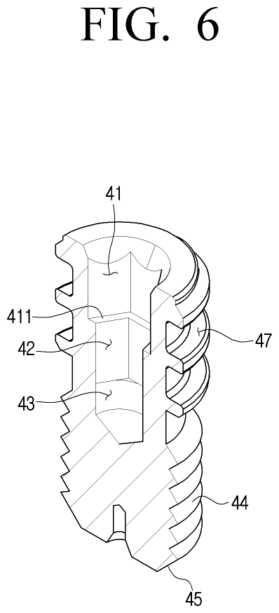

FIG. 3 is a perspective view illustrating a spindle 40 of a service valve 1 for an air conditioner according to an example embodiment. FIG. 4 is a cross-sectional view illustrating the spindle 40 of FIG. 3. FIG. 5 is an exploded perspective view illustrating the spindle 40 of FIG. 3. FIG. 6 is a cross-sectional perspective view illustrating the spindle 40 of FIG. 3 without a wrench guard 50.

Referring to FIGS. 3 to 6, the spindle 40 of the service valve 1 for an air conditioner according to an example embodiment may include a guard hole 41, a wrench guard 50, a screw portion 44, and an O-ring groove 47.

The guard hole 41 may be formed at a certain depth on the upper surface of the spindle 40. The guard hole 41 may be formed so that the wrench guard 50 is inserted into the guard hole 41. The spindle 40 may be formed of a brass material.

The guard hole 41 may be formed in a shape corresponding to the wrench guard 50. In detail, the cross-section of the guard hole 41 may be formed identically to the cross-section of the wrench guard 50. For example, the guard hole 41 may be formed as a polygonal hole.

In the case of this embodiment, because the cross-section of the outer circumferential surface 52 of the wrench guard 50 is formed as a regular hexagon, the cross-section of the guard hole 41 may be formed as a regular hexagon.

The guard hole 41 may be formed to have a depth that firmly and stably supports the wrench guard 50. The depth of the guard hole 41 may be defined according to the length of the wrench guard 50.

A step 411 may be provided at the bottom of the guard hole 41 to limit the insertion depth of the wrench guard 50. The step may be formed to protrude from the inner surface of the guard hole 41 to a certain height toward the center of the guard hole 41.

In the case where the wrench hole 42 is formed at the lower side of the guard hole 41, the upper end of the wrench hole 42 may form the step 411. In the case where there is only a drill groove 43 below the guard hole 41, the upper end of the drill groove 43 may form the step 411.

The wrench guard 50 may be disposed in the guard hole 41. The wrench guard 50 may be formed in a sleeve shape. In other words, the wrench guard 50 may have a through hole 51 formed in the center of the wrench guard 50. Therefore, the wrench guard 50 may include an inner circumferential surface and an outer circumferential surface. For example, the wrench guard 50 may be formed in a sleeve shape in which the cross-section of the inner circumferential surface of the through hole 51 is a regular hexagon.

The inner circumferential surface of the through hole 51 of the wrench guard 50 may be formed in a shape corresponding to a hexagonal wrench (Hex key). The hexagonal wrench refers to a tool used for removing and fastening a bolt or screw (Hex socket head cap screw) having a regular hexagonal groove formed on the head of the bolt. For example, in the case of an M4 hexagonal wrench, the through hole 51 of the wrench guard 50 may be formed in a regular hexagonal cross-section corresponding to the cross-section of the M4 hexagonal wrench.

The outer circumferential surface 52 of the wrench guard 50 may be formed in a shape corresponding to the guard hole 41. In detail, the cross-section of the outer circumferential surface 52 of the wrench guard 50 may be formed in a shape corresponding to the cross-section of the guard hole 41. In the case of this embodiment, because the cross-section of the guard hole 41 is formed in a regular hexagon, the cross-section of the outer circumferential surface 52 of the wrench guard 50 may be formed in a regular hexagon.

In other words, the wrench guard 50 according to this embodiment may be formed with the inner circumferential surface having a regular hexagonal cross-section and the outer circumferential surface 52 having a regular hexagonal cross-section.

The wrench guard 50 may be formed of stainless steel. The stainless steel may be either STS 304 or STS 316 (KS standard).

When the wrench guard 50 is formed of stainless steel, the spindle 40 made of brass may be prevented from being worn by the hexagonal wrench. In addition, when the wrench guard 50 is formed of stainless steel, the wrench guard 50 may be prevented from being corroded.

The wrench guard 50 may be formed to have a length that allows the hexagonal wrench to apply sufficient force to the spindle 40 to rotate the spindle 40 when rotating the spindle 40 with the hexagonal wrench.

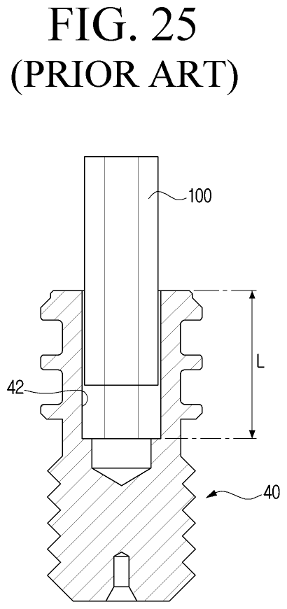

For example, as illustrated in FIG. 25, the spindle 40 may be formed of brass, and a regular hexagonal groove corresponding to a hexagonal wrench 100, that is, a wrench hole 42, may be formed on the upper surface of the spindle 40. In this case, the depth of the wrench hole 42 required to turn the spindle 40 without the wrench guard 50 with the hexagonal wrench 100 may be L. In other words, the depth of the brass wrench hole 42 is L. As in this embodiment, when the wrench guard 50 is disposed in the spindle 40 made of brass, the length of the wrench guard 50 may be L/2 or more.

In addition, the wrench guard 50 may be formed of thin stainless steel. The wrench guard 50 may be formed to have a thickness that prevents the wrench guard 50 from being damaged by the hexagonal wrench 100 when the spindle 40 is rotated with the hexagonal wrench 100. For example, the wrench guard 50 may be formed of stainless steel having a thickness of 0.3 mm to 0.5 mm.

Referring to FIGS. 4 and 6, the spindle 40 according to an example embodiment may include a guard hole 41 and a wrench hole 42.

The wrench hole 42 may be formed below the guard hole 41. The wrench hole 42 may be formed in a shape corresponding to the hexagonal wrench. In other words, the wrench hole 42 may be formed in a shape identical to the cross-section of the through hole 51 of the wrench guard 50. The wrench hole 42 may be formed in a regular hexagonal shape identical to the through hole 51 of the wrench guard 50.

The depth of the wrench hole 42 may be formed identical to the depth of the guard hole 41. Alternatively, the depth of the wrench hole 42 may be formed shorter than the depth of the guard hole 41.

In the case where the wrench hole 42 is formed in the spindle 40, when the spindle 40 is turned with the hexagonal wrench, the hexagonal wrench may be inserted into the through hole 51 of the wrench guard 50 and the wrench hole 42. Therefore, the hexagonal wrench may contact the inner circumferential surface of the wrench guard 50 and the inner circumferential surface of the wrench hole 42. Accordingly, the hexagonal wrench may stably rotate the spindle 40 and prevent the inner surface of the spindle 40 from being worn by the hexagonal wrench.

A drill groove 43 for forming the wrench hole 42 may be provided below the wrench hole 42.

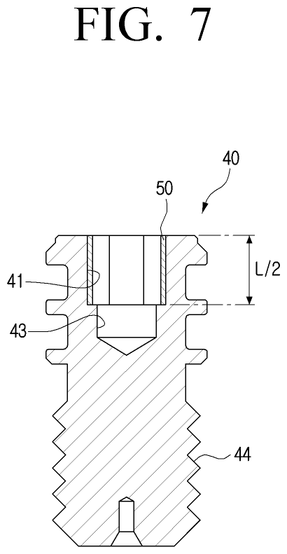

As another example, as illustrated in FIG. 7, the wrench hole 42 may not be formed below the guard hole 41.

FIG. 7 is a cross-sectional view illustrating a spindle 40 of a service valve 1 for an air conditioner according to an example embodiment.

Referring to FIG. 7, the guard hole 41 may be formed in the upper surface of the spindle 40, and the wrench guard 50 may be disposed in the guard hole 41. The depth of the guard hole 41 may be formed to be the same as the length of the wrench guard 50. The length of the wrench guard 50 may be approximately half the depth of the brass wrench hole 42. In other words, when the depth of the brass wrench hole 42 is L, the length of the wrench guard 50 may be L/2.

A drill groove 43 for forming the guard hole 41 may be provided below the guard hole 41.

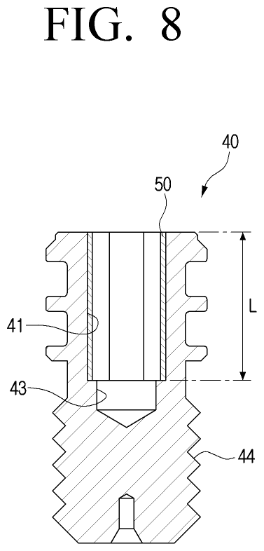

FIG. 8 is a cross-sectional view illustrating a spindle 40 of a service valve 1 for an air conditioner according to an example embodiment.

Referring to FIG. 8, the guard hole 41 may be formed in the upper surface of the spindle 40, and the wrench guard 50 may be disposed in the guard hole 41. The depth of the guard hole 41 may be formed to be the same as the length of the wrench guard 50. The length of the wrench guard 50 may be the same as the depth of the brass wrench hole 42. In other words, when the depth of the brass wrench hole 42 is L, the length of the wrench guard 50 may be L.

The drill groove 43 for forming the guard hole 41 may be provided below the guard hole 41.

The screw portion 44 may be formed on the outer circumferential surface of the spindle 40. The screw portion 44 may be formed on the lower portion of the outer circumferential surface of the spindle 40. The screw portion 44 may be formed as a male screw. The screw portion 44 may be formed as a male screw corresponding to the female screw portion 31 of the spindle receiving part 30. Therefore, the spindle 40 may be screw-coupled to the inside of the spindle receiving part 30.

Therefore, when the hexagonal wrench is inserted into the through hole 51 of the wrench guard 50 and the spindle 40 is rotated with the hexagonal wrench, the spindle 40 may move up and down inside the spindle receiving part 30.

The chamfer 45 corresponding to the chamfer of the spindle seat 24 may be provided at the lower end of the spindle 40, that is, below the screw portion 44.

The O-ring groove 47 may be formed on the outer circumferential surface of the spindle 40. The O-ring groove 47 may be formed on the upper portion of the outer circumferential surface of the spindle 40. In other words, the O-ring groove 47 may be provided above the screw portion 44 on the outer circumferential surface of the spindle 40. The O-ring 35 (see FIG. 2) may be disposed in the O-ring groove 47. The O-ring 35 may prevent refrigerant from leaking between the spindle 40 and the spindle receiving part 30.

In this embodiment, two O-ring grooves 47 are formed on the upper portion of the outer circumferential surface of the spindle 40. However, the number of O-ring grooves 47 formed on the outer circumferential surface of the spindle 40 may not be limited thereto. One or three or more O-ring grooves 47 may be provided on the spindle 40.

In the above, the case where the outer circumferential surface 52 of the wrench guard 50 is formed as a regular hexagon has been described, but the disclosure is not limited thereto. The outer circumferential surface 52 of the wrench guard 50 used in the spindle 40 according to the disclosure may be formed in various shapes as long as the wrench guard 50 can be prevented from rotating in the guard hole 41 of the spindle 40.

For example, the outer circumferential surface 52 of the wrench guard 50 may be formed as a polygon corresponding to the guard hole 41 formed as a polygonal hole.

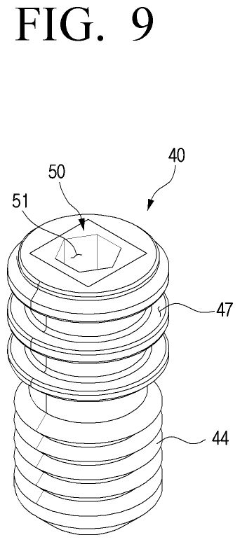

Hereinafter, a wrench guard 50 having a rectangular outer circumferential surface will be described with reference to FIGS. 9 to 12.

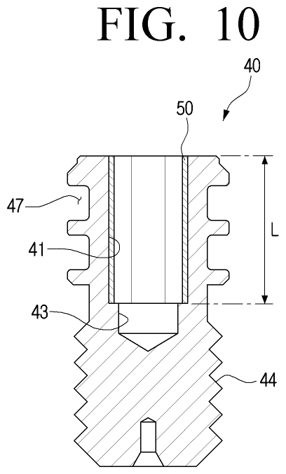

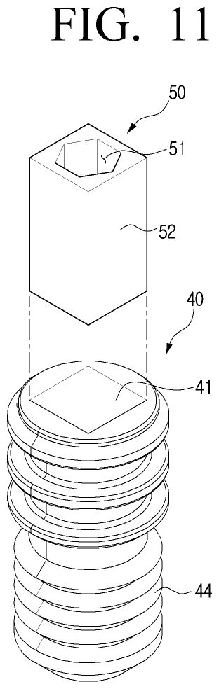

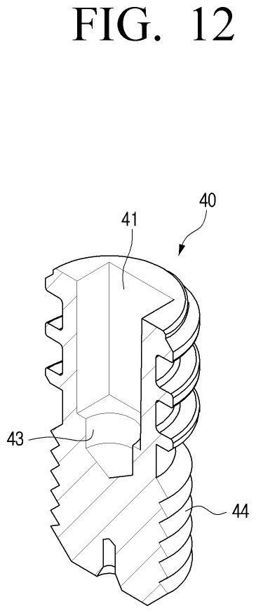

FIG. 9 is a perspective view illustrating a spindle 40 of a service valve 1 for an air conditioner according to an example embodiment. FIG. 10 is a cross-sectional view illustrating the spindle 40 of FIG. 9. FIG. 11 is an exploded perspective view illustrating the spindle 40 of FIG. 9. FIG. 12 is a cross-sectional perspective view illustrating the spindle 40 of FIG. 9 without a wrench guard 50.

Referring to FIGS. 9 to 12, a spindle 40 of the service valve 1 for an air conditioner according to an example embodiment may include a guard hole 41, a wrench guard 50, a screw portion 44, and an O-ring groove 47.

The guard hole 41 may be formed at a certain depth in the upper surface of the spindle 40. The guard hole 41 may be formed so that the wrench guard 50 is inserted into the guard hole 41. The spindle 40 may be formed of a brass material.

The guard hole 41 may be formed in a shape corresponding to the wrench guard 50. In detail, the cross-section of the guard hole 41 may be formed identically to the cross-section of the wrench guard 50. For example, the guard hole 41 may be formed as a polygonal hole.

In the case of this embodiment, because the cross-section of the outer circumferential surface 52 of the wrench guard 50 is formed as a square, the cross-section of the guard hole 41 may be formed as a square. In other words, the guard hole 41 may be formed as a square hole.

The guard hole 41 may be formed to have a depth that firmly and stably supports the wrench guard 50. The depth of the guard hole 41 may be defined according to the length of the wrench guard 50.

The wrench guard 50 may be disposed in the guard hole 41. The wrench guard 50 may be formed in a sleeve shape. In other words, the wrench guard 50 may have a through hole 51 formed in the center of the wrench guard 50. Therefore, the wrench guard 50 may include an inner circumferential surface and an outer circumferential surface. For example, the wrench guard 50 may be formed in a sleeve shape in which the cross-section of the through hole 51, that is, the cross-section of the inner circumferential surface thereof is a regular hexagon and the cross-section of the outer circumferential surface thereof is a square.

The through hole 51 of the wrench guard 50 may be formed in the same manner as the through hole 51 of the wrench guard 50 according to the above-described embodiment. In other words, the through hole 51 of the wrench guard 50 may be formed in a shape corresponding to the hexagonal wrench (Hex key).

The outer circumferential surface 52 of the wrench guard 50 may be formed in a shape corresponding to the guard hole 41. In the case of this embodiment, because the cross-section of the guard hole 41 is formed in a square shape, the cross-section of the outer circumferential surface 52 of the wrench guard 50 may be formed in a square shape.

In other words, the wrench guard 50 according to this embodiment may include the inner circumferential surface having a regular hexagonal cross-section and the outer circumferential surface having a square cross-section.

The wrench guard 50 may be formed of stainless steel. The stainless steel may be either STS 304 or STS 316 (KS standard).

The wrench guard 50 may be formed to have a length that allows the hexagonal wrench to apply sufficient force to the spindle 40 to rotate the spindle 40 when the hexagonal wrench is used to rotate the spindle 40.

In this embodiment, the length of the wrench guard 50 may be the same as the depth of the brass wrench hole 42. In other words, when the depth of the brass wrench hole 42 is L, the length of the wrench guard 50 may be L.

A drill groove 43 may be provided below the guard hole 41 to form the guard hole 41.

The screw portion 44 and the O-ring groove 47 are the same as the screw portion 44 and the O-ring groove 47 according to the above-described embodiment, so a detailed descriptions thereof are omitted.

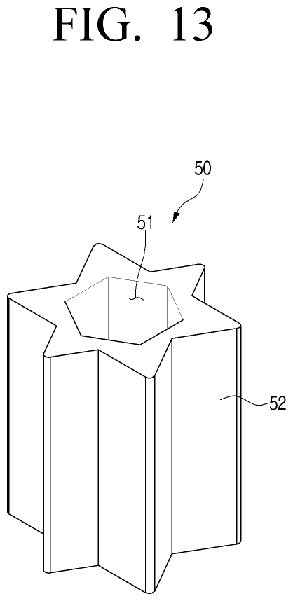

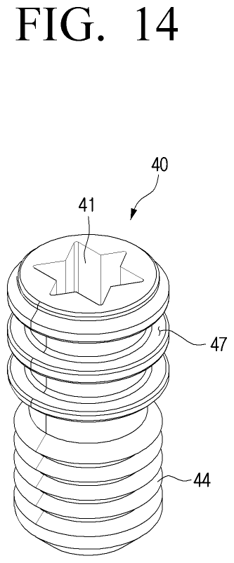

Hereinafter, a wrench guard 50 having an outer circumferential surface in the shape of a hexagonal star will be described with reference to FIGS. 13 and 14.

FIG. 13 is a perspective view illustrating a wrench guard 50 used in a spindle 40 of a service valve 1 for an air conditioner according to an example embodiment. FIG. 14 is a perspective view illustrating the spindle 40 of a service valve 1 for an air conditioner according to an example embodiment, in which the wrench guard 50 of FIG. 13 is disposed.

Referring to FIG. 13, the wrench guard 50 may be formed in a sleeve shape in which the cross-section of the through hole 51 is a regular hexagon and the cross-section of the outer circumferential surface 52 is a hexagonal star shape.

The through hole 51 of the wrench guard 50 may be formed in the same manner as the through hole 51 of the wrench guard 50 according to the above-described embodiment. In other words, the through hole 51 of the wrench guard 50 may be formed in a shape corresponding to the hexagonal wrench.

The cross-section of the outer circumferential surface 52 of the wrench guard 50 may be formed in a hexagonal star shape. In other words, the outer circumferential surface 52 of the wrench guard 50 may be formed in a hexagonal star pillar shape.

Therefore, the wrench guard 50 according to this embodiment may include the inner circumferential surface having a regular hexagonal cross-section and the outer circumferential surface having a hexagonal star-shaped cross-section.

The wrench guard 50 may be disposed in the guard hole 41 of the spindle 40.

Referring to FIG. 14, the guard hole 41 may be formed in the upper surface of the spindle 40. The guard hole 41 may be formed in a shape corresponding to the outer circumferential surface 52 of the wrench guard 50. In the case of this embodiment, because the cross-section of the outer circumferential surface 52 of the wrench guard 50 is formed in the hexagonal star shape, the cross-section of the guard hole 41 may be formed in the hexagonal star shape. In other words, the guard hole 41 may be formed as a hexagonal star hole.

Therefore, when the wrench guard 50 is inserted into the guard hole 41 of the spindle 40, the wrench guard 50 may not rotate relative to the guard hole 41.

The guard hole 41 may be formed to have a depth that firmly and stably supports the wrench guard 50. The depth of the guard hole 41 may be defined according to the length of the wrench guard 50.

In FIGS. 13 and 14, the cross-section of the outer circumferential surface 52 of the wrench guard 50 and the cross-section of the guard hole 41 are illustrated and described as having a hexagonal star shape. However, the cross-section of the outer circumferential surface 52 of the wrench guard 50 and the cross-section of the guard hole 41 are not limited to the hexagonal star shape. The cross-section of the outer circumferential surface 52 of the wrench guard 50 and the cross-section of the guard hole 41 may be formed in a polygonal star shape such as a pentagonal star, a heptagonal star, an octagonal star, etc.

In the above, the case where the cross-section of the outer circumferential surface 52 of the wrench guard 50 is a square or polygonal star shape has been described, but the wrench guard 50 according to the disclosure is not limited thereto. The cross-section of the outer circumferential surface 52 of the wrench guard 50 may be formed as a polygon greater than a triangle, a pentagon, or a hexagon or more polygonal shape. In addition, the cross-section of the outer circumferential surface 52 of the wrench guard 50 may be formed in an elliptical shape.

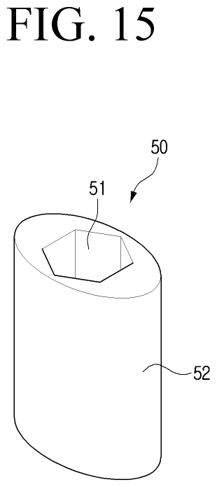

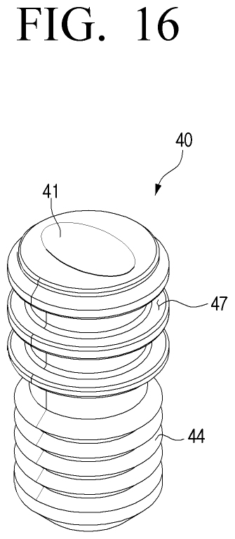

Hereinafter, a wrench guard 50 having an elliptical outer circumferential surface will be described with reference to FIGS. 15 and 16.

FIG. 15 is a perspective view illustrating a wrench guard 50 used in a spindle 40 of a service valve 1 for an air conditioner according to an example embodiment. FIG. 16 is a perspective view illustrating the spindle 40 of the service valve 1 for an air conditioner according to an example embodiment, in which the wrench guard 50 of FIG. 15 is disposed.

Referring to FIG. 15, the wrench guard 50 may be formed in a sleeve shape in which the cross-section of the through hole 51 is a regular hexagon and the cross-section of the outer circumferential surface 52 is an elliptical shape.

The through hole 51 of the wrench guard 50 may be formed in the same manner as the through hole 51 of the wrench guard 50 according to the above-described embodiment. In other words, the through hole 51 of the wrench guard 50 may be formed in a shape corresponding to the hexagonal wrench.

The cross-section of the outer circumferential surface of the wrench guard 50 may be formed in an elliptical shape. In other words, the outer circumferential surface of the wrench guard 50 may be formed in an elliptical pillar shape.

Therefore, the wrench guard 50 according to this embodiment may include the inner circumferential surface having a regular hexagonal cross-section and the outer circumferential surface 52 having an elliptical cross-section.

Referring to FIG. 16, the guard hole 41 may be formed in the upper surface of the spindle 40. The guard hole 41 may be formed in a shape corresponding to the outer circumferential surface 52 of the wrench guard 50. In the case of this embodiment, because the cross-section of the outer circumferential surface 52 of the wrench guard 50 is formed in the elliptical shape, the cross-section of the guard hole 41 may be formed in the elliptical shape. In other words, the guard hole 41 may be formed as an elliptical hole.

Therefore, when the wrench guard 50 is inserted into the guard hole 41 of the spindle 40, the wrench guard 50 may not rotate relative to the guard hole 41.

The guard hole 41 may be formed to have a depth that firmly and stably supports the wrench guard 50. The depth of the guard hole 41 may be defined according to the length of the wrench guard 50.

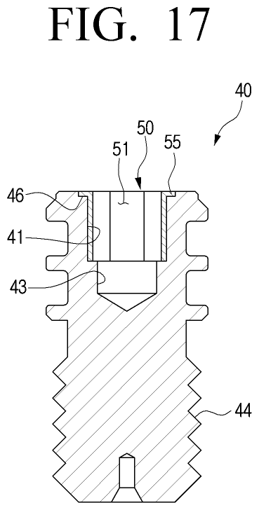

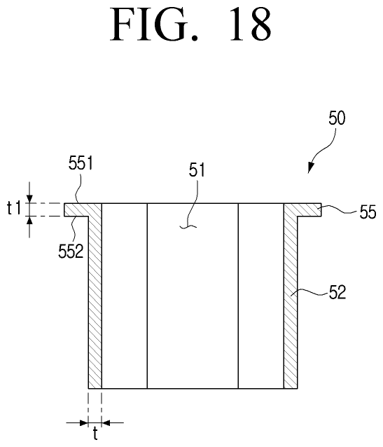

The wrench guard 50 may include a stopper so as not to fall out of the guard hole 41. Hereinafter, a wrench guard 50 having a stopper will be described with reference to FIGS. 17 and 18.

FIG. 17 is a cross-sectional view illustrating a spindle 40 of a service valve 1 for an air conditioner according to an example embodiment. FIG. 18 is a cross-sectional view illustrating a wrench guard 50 used in the spindle 40 of FIG. 17.

Referring to FIGS. 17 and 18, the wrench guard 50 may include a stopper 55.

The stopper 55 may be provided at the upper end of the wrench guard 50. The stopper 55 may be formed to extend radially from the upper end of the wrench guard 50. In other words, the stopper 55 may be formed in a flange shape at the upper end of the wrench guard 50.

The stopper 55 may be formed in the same shape as the outer circumferential surface 52 of the wrench guard 50. For example, when the outer circumferential surface 52 of the wrench guard 50 is formed in a regular hexagon, the stopper 55 may be formed in a regular hexagon. Alternatively, the stopper 55 may be formed in a circular shape.

The thickness t1 of the stopper 55 may be formed to be less than or equal to the thickness t of the wrench guard 50. The upper surface 551 of the stopper 55 and the lower surface 552 of the stopper 55 may be formed parallel to each other. In other words, the cross-section of the stopper 55 may be formed in a rectangular shape.

A stopper seat 46 may be provided at the upper end of the guard hole 41 of the spindle 40. When the wrench guard 50 is inserted into the guard hole 41, the stopper 55 of the wrench guard 50 may be received in the stopper seat 46 of the guard hole 41.

Because the stopper 55 of the wrench guard 50 is forcibly fitted into the stopper seat 46 of the guard hole 41, the wrench guard 50 may not fall out of the guard hole 41 of the spindle 40.

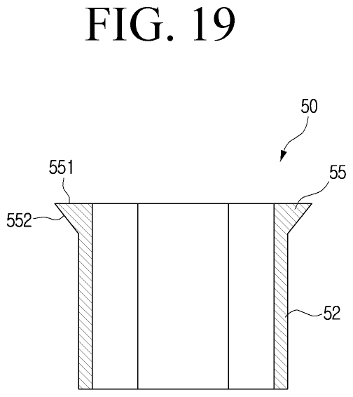

In the above-described embodiment, the lower surface 552 of the stopper 55 is formed parallel to the upper surface 551 of the stopper 55. However, the lower surface 552 of the stopper 55 may be formed inclined with respect to the upper surface 552 of the stopper 55, as illustrated in FIG. 19.

FIG. 19 is a cross-sectional view illustrating a wrench guard 50 used in a spindle 40 of a service valve 1 for an air conditioner according to an example embodiment.

Referring to FIG. 19, the upper surface 551 of the stopper 55 may be formed parallel to the lower surface of the wrench guard 50, and the lower surface 552 of the stopper 55 may be formed inclined upward with respect to the upper surface 551 of the stopper 55. Therefore, the cross-section of the stopper 55 may be formed in a right-angled triangle shape.

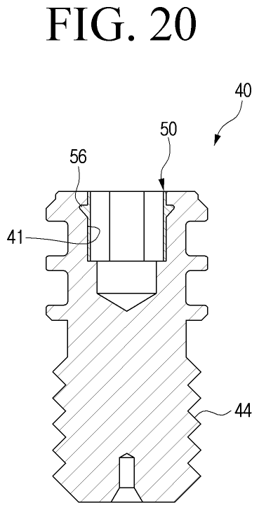

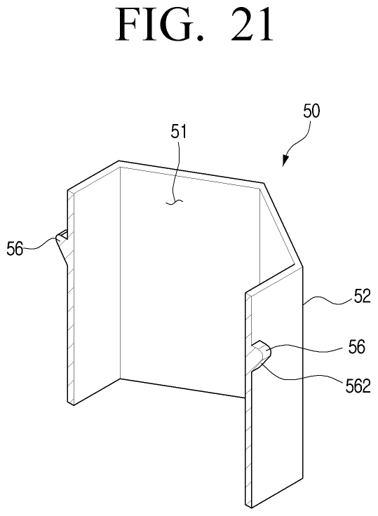

The wrench guard 50 may include a fixing protrusion to prevent the wrench guard 50 from falling out of the guard hole 41. Hereinafter, a wrench guard 50 having a fixing protrusion will be described with reference to FIGS. 20 and 21.

FIG. 20 is a cross-sectional view illustrating a spindle 40 of a service valve 1 for an air conditioner according to an example embodiment. FIG. 21 is a cross-sectional perspective view illustrating a wrench guard 50 used in the spindle 40 of FIG. 20.

Referring to FIGS. 20 and 21, the wrench guard 50 may include a fixing protrusion 56.

The fixing protrusion 56 may be formed on the outer circumferential surface of the wrench guard 50. The fixing protrusion 56 may be formed to protrude outward from the outer circumferential surface 52 of the wrench guard 50. For example, when the outer circumferential surface 52 of the wrench guard 50 is formed as a regular hexagonal column, the fixing protrusion 56 may be formed to protrude from the outer surface of the regular hexagonal column.

The fixing protrusion 56 may be positioned below the upper end of the wrench guard 50. The fixing protrusion 56 may be positioned on the upper portion of the wrench guard 50. In other words, the fixing protrusion 56 may be positioned above the center of the wrench guard 50 in the longitudinal direction of the wrench guard 50.

Two or more fixing protrusions 56 may be formed. Two or more fixing protrusions 56 may be symmetrically provided on the outer circumferential surface 52 of the wrench guard 50.

The fixing protrusion 56 may be formed to have a downwardly inclined surface 562. For example, the fixing protrusion 56 may be formed in a triangular cross-section. In the case where the fixing protrusion 56 has the downwardly inclined surface 562, when the wrench guard 50 equipped with the fixing protrusion 56 is inserted into the guard hole 41 of the spindle 40, the wrench guard 50 may be easily inserted into the guard hole 41.

The wrench guard 50 may be formed of thin stainless steel. For example, the wrench guard 50 may be formed of stainless steel having a thickness of 0.3 mm to 0.5 mm. Therefore, when a plurality of fixing protrusions 56 are provided on the outer circumferential surface 52 of the wrench guard 50, the wrench guard 50 may be easily inserted into the guard hole 41 of the spindle 40 due to elastic deformation of the wrench guard 50.

Because the spindle 40 is formed of brass and the fixing protrusion 56 of the wrench guard 50 is formed of stainless steel, the fixing protrusion 56 of the wrench guard 50 may be inserted into and fixed on the inner circumferential surface of the guard hole 41 of the spindle 40.

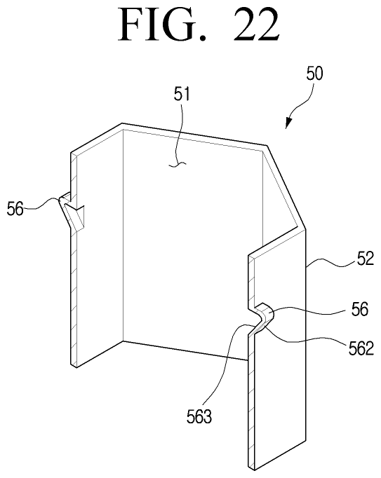

The fixing protrusion 56 may be formed by molding the wrench guard 50 as illustrated in FIG. 22.

FIG. 22 is a cross-sectional perspective view illustrating a wrench guard 50 used in a spindle 40 of a service valve 1 for an air conditioner according to an example embodiment.

Referring to FIG. 22, the wrench guard 50 may include a fixing protrusion 56. The fixing protrusion 56 may be formed by molding the wrench guard 50.

For example, because the wrench guard 50 is formed of thin stainless steel, a force may be applied to the outside from one point on the inner circumferential surface of the wrench guard 50 to form the fixing protrusion 56. Then, a concave groove 563 may be formed on the inner circumferential surface of the wrench guard 50, and an externally convex fixing protrusion 56 may be formed on the outer circumferential surface 52 of the wrench guard 50.

The fixing protrusion 56 may be positioned below the upper end of the wrench guard 50. The fixing protrusion 56 may be positioned on the upper portion of the wrench guard 50. In other words, the fixing protrusion 56 may be positioned above the center of the wrench guard 50 in the longitudinal direction of the wrench guard 50.

Two or more fixing protrusions 56 may be formed. Two or more fixing protrusions 56 may be symmetrically provided on the outer circumferential surface 52 of the wrench guard 50.

The fixing protrusion 56 may be formed to have a downwardly inclined surface 562. For example, the fixing protrusion 56 may be formed in a triangular cross-section.

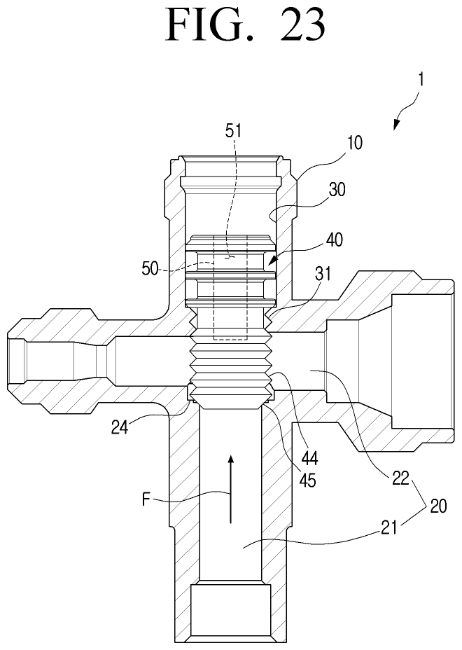

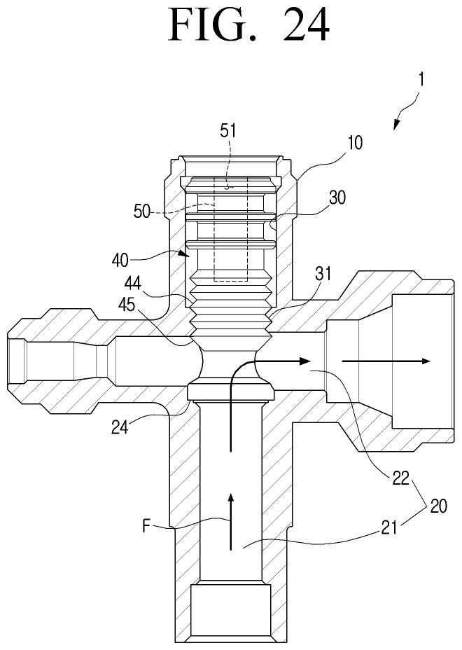

Hereinafter, the operation of the spindle 40 of the service valve 1 for an air conditioner according to an example embodiment will be described with reference to FIGS. 23 and 24.

FIG. 23 is a cross-sectional view illustrating a state in which a service valve 1 for an air conditioner according to an example embodiment is closed by a spindle 40.

Referring to FIG. 23, the spindle 40 may be disposed in the spindle receiving part 30 of the service valve 1. At this time, the male screw of the screw portion 44 of the spindle 40 is fastened to the female screw portion 31 of the spindle receiving part 30.

The lower end of the spindle 40 may contact the spindle seat 24 provided at the upper end of the first fluid passage 21. In other words, the chamfer 45 of the lower end of the spindle 40 may contact the spindle seat 24 of the body 10. Therefore, the fluid passage 20 provided in the body 10 may be blocked by the spindle 40.

In this state, when a hexagonal wrench is inserted into the through hole 51 of the wrench guard 50 of the spindle 40 and the hexagonal wrench is turned, the spindle 40 may rotate. When the hexagonal wrench is turned in one direction, the spindle 40 may move upward in the spindle receiving part 30.

When the spindle 40 moves upward, the lower end of the spindle 40 is separated from the spindle seat 24 of the first fluid passage 21, so that the first fluid passage 21 and the second fluid passage 22 may be connected, directly or indirectly, to each other.

When the hexagonal wrench is continuously turned, the spindle 40 may rise and the fluid passage 20 may be opened to the maximum as illustrated in FIG. 24.

FIG. 24 is a cross-sectional view illustrating a state in which a service valve 1 for an air conditioner according to an example embodiment is opened by a spindle 40.

Referring to FIG. 24, when the service valve 1 is fully opened, the upper end of the spindle 40 may be adjacent to the upper end of the spindle receiving part 30, and the lower end of the spindle 40 may be maximally spaced from the spindle seat 24.

Then, the refrigerant (arrow F) may circulate between the outdoor unit and the indoor unit through the fluid passage 20 formed with the first fluid passage 21, the central space 23, and the second fluid passage 22.

In FIG. 24, when the hexagonal wrench is inserted into the through hole 51 of the wrench guard 50 of the spindle 40 and the hexagonal wrench is rotated in the opposite direction, the spindle 40 may move downward in the spindle receiving part 30.

When the spindle 40 moves downward and the chamfer 45 of the lower end of the spindle 40 comes into contact with the spindle seat 24, the fluid passage 20 may be blocked by the spindle 40. In other words, as illustrated in FIG. 23, the service valve 1 may be closed by the spindle 40.

FIG. 25 is a cross-sectional view illustrating a state in which a hexagonal wrench 100 is inserted into a wrench hole 42 of a spindle 40 of a service valve 1 for an air conditioner according to the prior art.

Referring to FIG. 25, a wrench hole 42 may be provided on the upper surface of a spindle 40. The wrench hole 42 may be formed in a shape corresponding to the hexagonal wrench 100. In other words, because the hexagonal wrench 100 has a regular hexagonal cross-section, the wrench hole 42 may be formed in a regular hexagonal cross-section.

The wrench hole 42 may be formed to have a depth that allows the hexagonal wrench 100 to apply sufficient force to the spindle 40 to rotate the spindle 40 when the spindle 40 is rotated with the hexagonal wrench 100 inserted into the wrench hole 42. When the spindle 40 is formed of a brass material, the depth of the wrench hole 42 required to rotate the spindle 40 without damaging the wrench hole 42 with the hexagonal wrench 100 may be L. In other words, the depth of the brass wrench hole 42 may be L.

In the case where the wrench hole 42 is formed of brass, when the hexagonal wrench 100 is not fully inserted into the wrench hole 42, the inner surface of the wrench hole 42 may be worn by the hexagonal wrench 100 when the spindle 40 is rotated with the hexagonal wrench 100. Generally, the hexagonal wrench 100 is formed of stainless steel, steel, or the like, which has greater strength than brass, so when the hexagonal wrench 100 is not fully inserted into the wrench hole 42 of the spindle 40, the wrench hole 42 may be damaged by the hexagonal wrench 100.

However, because the service valve 1 according to an example embodiment has the wrench guard 50 formed of stainless steel disposed on the upper surface of the spindle 40, when the hexagonal wrench 100 is not fully inserted into the wrench guard 50, the wrench guard 50 may not be damaged by the hexagonal wrench 100.

In addition, when the wrench guard 50 of the service valve 1 according to an example embodiment is formed to have a length that is half the length of the brass wrench hole 42, the spindle 40 may be easily rotated with the hexagonal wrench 100.

In the case of closing the fluid passage 20 with the spindle 40, when the spindle 40 is rotated excessively, the lower end of the spindle 40 and the spindle seat 24 may be bonded by pressure. When the spindle 40 is bonded by pressure in this way, in the case where the wrench hole 42 of the spindle 40 is formed of brass as in the prior art, when the spindle 40 is rotated in the opposite direction using the hexagonal wrench 100, the bonding by pressure may not be released and the wrench hole 42 of the spindle 40 may be worn by the hexagonal wrench 100. In other words, the service valve 1 according to the prior art has a problem in that the spindle 40 may not be released when the spindle 40 is bonded by pressure.

However, in the case where the wrench guard 50 is disposed on the upper portion of the spindle 40, such as in the service valve 1 according to an example embodiment, when the spindle 40 is bonded by pressure, the spindle 40 may be rotated by inserting the hexagonal wrench 100 into the through hole 51 of the wrench guard 50 and turning the hexagonal wrench 10 in the opposite direction to release the bonding by pressure of the spindle 40.

In the case of this disclosure, because the wrench guard 50 to which the hexagonal wrench 100 applies a force is formed of stainless steel, a force greater than the bonding force generated by the bonding by pressure between the lower end of the spindle 40 and the spindle seat 24 formed of brass may be applied to the wrench guard 50. Therefore, the service valve 1 according to an example embodiment may release the spindle 40 when the spindle 40 is bonded by pressure.

According to an example embodiment, the service valve 1 may form the spindle 40 itself from stainless steel. In this case, there is no need to dispose the wrench guard 50 formed of stainless steel on the upper surface of the spindle 40. Therefore, only a wrench hole 42 may be formed on the upper surface of the spindle 40 without the guard hole 41.

When the spindle 40 is rotated by inserting the hexagonal wrench 100 into the wrench hole 42, the wrench hole 42 of the spindle 40 formed from stainless steel may not wear out due to the hexagonal wrench 100.

In addition, because a large force may be applied to the wrench hole 42 with the hexagonal wrench 100, the spindle 40 may be released when the boding by pressure of the spindle 40 occurs.

In addition, when the lower end of the spindle 40 is positioned on the spindle seat 24 of the body 10, the contact between the lower end of the spindle 40 formed of stainless steel and the spindle seat 24 of the body 10 formed of brass may be strengthened, so that the sealing between the spindle 40 and the spindle seat 24 may be improved.

In the foregoing, the disclosure has been shown and described with reference to various embodiments. However, it is understood by those skilled in the art that various changes may be made in form and detail without departing from the scope of the disclosure as defined by the appended claims and equivalents thereof.

1. A service valve for an air conditioner comprising:
a body;
a fluid passage configured to penetrate the body;
a spindle receiving part configured to communicate with the fluid passage;
a spindle screw-connected to the spindle receiving part and configured to open and block the fluid passage;
a guard hole configured at a depth on an upper surface of the spindle; and
a wrench guard disposed at least partially in the guard hole.

2. The service valve for an air conditioner of claim 1, wherein
the wrench guard is formed in a sleeve shape including a through hole, and
a cross-section of the through hole is a regular hexagon.

3. The service valve for an air conditioner of claim 2, wherein
the guard hole is formed as a polygonal hole, and
an outer circumferential surface of the wrench guard is configured as a polygon corresponding to the polygonal hole of the guard hole.

4. The service valve for an air conditioner of claim 3, wherein
the polygonal hole is formed as one of: a square hole, a hexagonal hole, and a polygonal star hole.

5. The service valve for an air conditioner of claim 2, wherein
the guard hole is configured as an elliptical hole, and
an outer circumferential surface of the wrench guard is configured as an elliptical shape corresponding to the elliptical hole of the guard hole.

6. The service valve for an air conditioner of claim 2, wherein
the wrench guard includes a stopper provided at an upper end of the wrench guard, and the wrench guard is fixed to the guard hole by at least the stopper.

7. The service valve for an air conditioner of claim 2, wherein
the wrench guard includes a fixing protrusion provided on an outer circumferential surface of the wrench guard, and the wrench guard is fixed to the guard hole by at least the fixing protrusion.

8. The service valve for an air conditioner of claim 2, further comprising:
a wrench hole formed below the guard hole.

9. The service valve for an air conditioner of claim 8, wherein
a length of the wrench guard is equal to or greater than a depth of the wrench hole.

10. The service valve for an air conditioner of claim 9, wherein
the length of the wrench guard is at least 5 mm.

11. The service valve for an air conditioner of claim 1, wherein
a material of the body comprises brass, and
a material of the wrench guard comprises stainless steel.

12. The service valve for an air conditioner of claim 11, wherein
a length of the wrench guard is at least ½ of a depth of a brass wrench hole.

13. The service valve for an air conditioner of claim 1, wherein
the body is configured in a cross shape,
the fluid passage is on an inside of a leg, a center portion, and a right arm of the body, and
the spindle receiving part is configured to connect an upper surface of a head of the body and the center portion.

14. The service valve for an air conditioner of claim 13, wherein
the spindle receiving part includes a female screw portion, and
the spindle includes a screw portion fastened to the female screw portion.

15. The service valve for an air conditioner of claim 11, wherein
a thickness of the wrench guard is from 0.3 mm to 0.5 mm.
